(19) United States
(12) Patent Application Publication
(10) Pub. No.: US 2023/0309187 A1
(43) Pub. Date: Sep. 28, 2023

(54) COMMUNICATION APPARATUS AND COMMUNICATION METHOD

(71) Applicant: Panasonic Holdings Corporation, Osaka (JP)

(72) Inventors: Shotaro MAKI, Kanagawa (JP); Akihiko NISHIO, Osaka (JP); Yasuaki YUDA, Kanagawa (JP); Toshiaki SAKURAI, Kanagawa (JP)

(21) Appl. No.: 18/187,483

(22) Filed: Mar. 21, 2023

(30) Foreign Application Priority Data
Mar. 24, 2022 (JP) 2022-049029

(51) Int. Cl. H04W 76/30; H04W 72/0453; H04W 76/15

(52) U.S. Cl. CPC H04W 76/30; H04W 72/0453; H04W 76/15

(57) ABSTRACT

A communication apparatus includes: control circuitry which, in operation, in accordance with a condition, makes a setting of enabling or disabling of first communication using a first radio frequency band and makes a setting of enabling or disabling of second communication using a second radio frequency band lower than the first radio frequency band; and communication circuitry which, in operation, performs the first communication or the second communication in accordance with the setting of the enabling or disabling of the first communication and the setting of the enabling or disabling of the second communication.

### BACKGROUND

### 1. Technical Field

The present disclosure relates to a communication apparatus and a communication method.

### 2. Description of the Related Art

In cellular wireless communication including 5G new radio access technology (NR), communication using a baseband radio waveform is performed.

### SUMMARY

However, there is room for study on a method for improving the performance of wireless communication.

A non-limiting exemplary embodiment of the present disclosure contributes to providing a communication apparatus and a communication method capable of improving the performance of wireless communication.

A communication apparatus according to an exemplary embodiment of the present disclosure includes: control circuitry which, in operation, in accordance with a condition, makes a setting of enabling or disabling of first communication using a first radio frequency band and makes a setting of enabling or disabling of second communication using a second radio frequency band lower than the first radio frequency band; and communication circuitry which, in operation, performs the first communication or the second communication in accordance with the setting of the enabling or disabling of the first communication and the setting of the enabling or disabling of the second communication.

It should be noted that general or specific embodiments may be implemented as a system, a method, an integrated circuit, a computer program, a storage medium, or any selective combination thereof.

According to an exemplary embodiment of the present disclosure, the performance of wireless communication can be improved.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a block diagram illustrating a configuration example of a part of a communication apparatus;

FIG. 2 is a block diagram illustrating a configuration example of the communication apparatus;

FIG. 3 is a block diagram illustrating a configuration example of the communication apparatus;

FIG. 4 is a block diagram illustrating a configuration example of the communication apparatus;

FIG. 5 is a block diagram illustrating a configuration example of the communication apparatus;

FIG. 6 is a block diagram illustrating a configuration example of the communication apparatus; and

FIG. 7 is a diagram illustrating an operation example of the communication apparatus.

### DETAILED DESCRIPTIONS

Hereinafter, exemplary embodiments of the present disclosure will be described in detail with reference to the drawings.

In cellular wireless communication including 5G NR, radio waves in a microwave band and a millimeter wave band are utilized. In a 6G system (sixth generation mobile communication system), utilization of radio waves in a terahertz band of 100 GHz or more (alternatively, the sub-terahertz band) is further studied. For example, a system that uses a terahertz wave for communication near a terminal has been proposed in Kosuke Yamazaki, Takeo Ohseki, Yoshiaki Amano, Takahide Murakami, Hiroyuki Shinbo, Yoji Kishi, “PROPOSAL FOR A USER-CENTRIC RAN ARCHITECTURE TOWARDS BEYOND 5G”, IEICE Technical Report, vol. 121, no. 189, SAT2021-43, pp. 4-10, October 2021 (hereinafter, referred to as Non-Patent Literature 1).

For example, in communication (hereinafter, referred to as “first communication”) discussed in Non-Patent Literature 1, a terminal (or a user terminal) communicates with a base station via a relay device (for example, a repeater) near the terminal. In the first communication, communication between the terminal and the relay device may be, for example, wireless communication using a relatively high radio frequency (For example, also referred to as a frequency band or a carrier frequency) such as a terahertz band or a 300 GHz band. Note that, in the first communication, the communication between the relay device and the base station may be, for example, wireless communication using a relatively low radio frequency such as a millimeter wave band or a 30 GHz band.

Furthermore, for example, in a situation where the first communication is difficult for some reason, the terminal may directly communicate with a base station near the terminal as other communication (hereinafter, “second communication”). In the second communication, the communication between the terminal and the base station may be, for example, wireless communication using a relatively low radio frequency such as a millimeter wave band or a 30 GHz band.

The terminal may be required to have, for example, capabilities corresponding to both the first communication and the second communication.

Here, as a circuit configuration of the terminal, a circuit corresponding to the first communication and a circuit corresponding to the second communication may be independently provided. In such a circuit configuration, a manufacturing cost or a circuit scale of the terminal may be increased. Therefore, between the first communication and the second communication, it is desirable to commonize or reuse a circuit to be implemented as much as possible.

Furthermore, a method of setting enabling and disabling of each of the first communication and the second communication has not been sufficiently studied.

In a non-limiting exemplary embodiment of the present disclosure, for example, a method of simplifying a circuit configuration of a terminal corresponding to the first communication and the second communication, and a method of appropriately setting enabling and disabling of each of the first communication and the second communication will be described.

[Overview of Communication System]

A communication system according to an exemplary embodiment of the present disclosure includes at least one communication apparatus 100. Communication apparatus 100 may be, for example, a base station (for example, also referred to as a gNB) or a terminal (for example, user equipment (UE)).

For example, communication apparatus 100 may perform at least one of transmission and reception in each of the first communication and the second communication.

In the following description, as an example, the first communication may be wireless communication using a terahertz band or a 300 GHz band, and the second communication may be wireless communication using a millimeter wave band or a 30 GHz band.

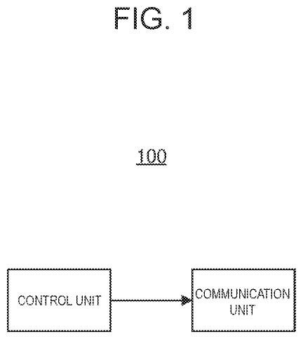

FIG. 1 is a block diagram illustrating a configuration example of a part of communication apparatus 100. In communication apparatus 100 illustrated in FIG. 1, a control unit (for example, corresponding to control circuitry) sets, in accordance with a condition, enabling and disabling of each of the first communication using a first radio frequency band and the second communication using a second radio frequency band lower than the first radio frequency band. A communication unit (for example, corresponding to communication circuitry) performs the first communication or the second communication in accordance with the enable and disable setting.

[Configuration Example of Communication Apparatus]

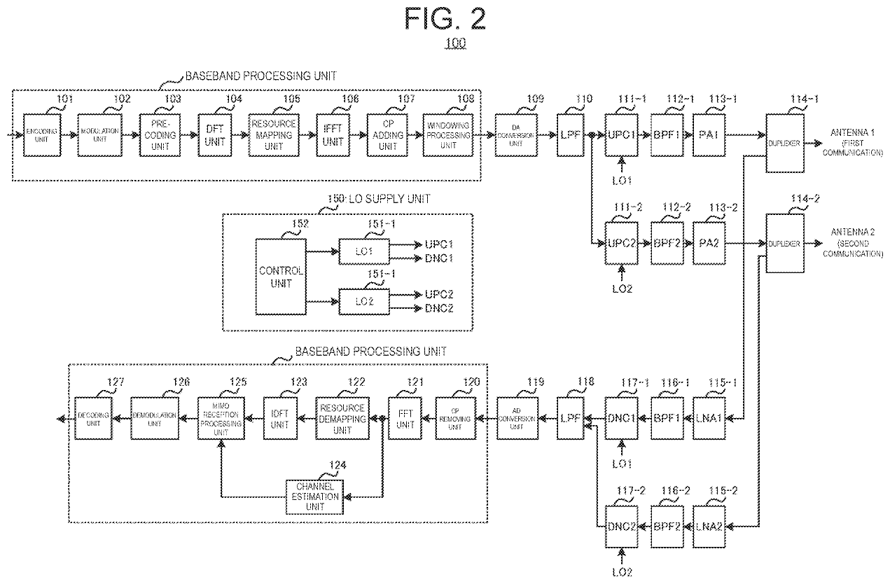

FIG. 2 is a block diagram illustrating an example of a configuration of communication apparatus 100 according to the present exemplary embodiment.

In communication apparatus 100 illustrated in FIG. 2, an upper component (for example, encoding unit 101 to Power Amplifier (PA) 113) constitutes a “transmission unit” that performs signal transmission processing, and a lower component (for example, Low Noise Amplifier (LNA) 115 to decoding unit 127) constitutes a “reception unit” that performs signal reception processing.

Furthermore, communication apparatus 100 includes local oscillator (LO) supply unit 150 that outputs a signal (For example, it is referred to as an LO signal) of an LO to the transmission unit and the reception unit.

At least one of encoding unit 101 to windowing processing unit 108, CP removing unit 120 to decoding unit 127, and LO supply unit 150 illustrated in FIG. 2 may be included in, for example, the control unit illustrated in FIG. 1. Furthermore, at least one of DA conversion unit 109 to AD conversion unit 119 illustrated in FIG. 2 may be included in, for example, the communication unit illustrated in FIG. 1.

<Transmission Processing>

In FIG. 2, encoding unit 101, modulation unit 102, precoding unit 103, discrete Fourier transform (DFT) unit 104, resource mapping unit 105, inverse fast Fourier transform (IFFT) unit 106, cyclic prefix (CP) adding unit 107, and windowing processing unit 108 may be included in a “baseband processing unit”. In FIG. 2, DA conversion unit 109, low pass filter (LPF) 110, up-converter (UPC) 111, band pass filter (BPF) 112, power amplifier (PA) 113, and duplexer 114 may be included in an “analogue radio frequency (RF) processing unit” (not illustrated).

Furthermore, in FIG. 2, communication apparatus 100 may individually include UPC 111, BPF 112, PA 113, and duplexer 114 for each of a plurality of communications (for example, including the first communication and the second communication). In the example illustrated in FIG. 2, communication apparatus 100 may include UPC 111-1 (also referred to as UPC1), BPF 112-1 (also referred to as BPF1), PA 113-1 (also referred to as PA1), and duplexer 114-1 for the first communication, and UPC 111-2 (also referred to as UPC2), BPF 112-2 (also referred to as BPF2), PA 113-2 (also referred to as PA2), and duplexer 114-2 for the second communication.

Furthermore, for example, at least one processing of DFT unit 104, IFFT unit 106, CP adding unit 107, and windowing processing unit 108 may be omitted in accordance with a wireless waveform of a signal to be transmitted.

Furthermore, in a case where MIMO transmission using a plurality of antennas is performed in each radio frequency band, the processing after precoding unit 103 illustrated in FIG. 2 may be performed for each antenna system.

In FIG. 2, encoding unit 101 performs error correction coding on a signal by using coding methods such as turbo coding, low density parity check (LDPC) coding, and polar coding.

For example, modulation unit 102 maps encoded bit string to an IQ constellation such as quadrature phase shift keying (QPSK) and 16-quadrature amplitude modulation (16QAM) to generate modulation symbols.

For example, precoding unit 103 performs precoding processing (for example, weighting processing on the modulation symbols) for MIMO transmission on the modulation symbols input from modulation unit 102. Note that, in a case where communication apparatus 100 does not perform MIMO transmission, precoding unit 103 does not need to perform processing.

For example, DFT unit 104 performs DFT processing (also referred to as DFT spreading or DFT precoding) on a signal input from precoding unit 103.

Resource mapping unit 105 maps the signal after the DFT processing to a frequency resource (for example, a subcarrier or a resource block (RB)) used for transmission.

IFFT unit 106 performs, for example, IFFT processing on the signal mapped to the frequency resource.

CP adding unit 107 adds a CP by, for example, copying a sample of a part (for example, a rear part of an OFDM symbol) of the signal after the IFFT to a head.

Windowing processing unit 108 performs windowing processing on the signal to which the CP is added (for example, OFDM symbols). The windowing processing is, for example, processing for reducing out-of-band radiation power due to discontinuity between the OFDM symbols. For the windowing processing, for example, a window function of a root raised cosine waveform may be used. Furthermore, windowing processing unit 108 may perform, for example, weighted overlap and add (WOLA) processing of causing the adjacent OFDM symbols to overlap with each other. Furthermore, filtering processing may be performed instead of the windowing processing, or another waveform shaping processing for limiting the frequency band may be performed.

DA conversion unit 109 performs digital-analogue conversion on a baseband signal (radio waveform) input from the baseband processing unit (for example, windowing processing unit 108).

LPF 110 performs, for example, LPF processing of passing a desired low frequency component of the signal input from DA conversion unit 109.

UPC 111 up-converts a frequency of the signal input from LPF 110 to a transmission frequency based on a signal input from the LO supply unit 150, for example. Note that UPC 111 may use, for example, a plurality of stages of the up-converters.

For example, BPF 112 performs filter processing of passing a desired band component on the signal input from UPC 111.

For example, PA 113 amplifies the signal input from BPF 112 to desired transmission power.

Duplexer 114 switches between transmission and reception. The transmission and the reception may be switched at a switching timing between uplink and downlink of a time division duplex (TDD) frame, for example.

<Reception Processing>

In FIG. 2, CP removing unit 120, fast Fourier transform (FFT) unit 121, resource demapping unit 122, inverse discrete Fourier transform (IDFT) unit 123, channel estimation unit 124, MIMO reception processing unit 125, demodulation unit 126, and decoding unit 127 may be included in the “baseband processing unit”. Note that, in FIG. 2, duplexer 114, LNA 115, BPF 116, down-converter (DNC) 117, LPF 118, and AD conversion unit 119 may be included in the “analogue RF processing unit” (not illustrated).

Furthermore, in FIG. 2, communication apparatus 100 may individually include duplexer 114, LNA 115, BPF 116, and DNC 117 for each of a plurality of communications (for example, including the first communication and the second communication). In the example illustrated in FIG. 2, communication apparatus 100 may include duplexer 114-1, LNA 115-1 (also referred to as LNA1), BPF 116-1 (also referred to as BPF1), and DNC 117-1 (also referred to as DNC1) for the first communication, and duplexer 114-2, LNA 115-2 (also referred to as LNA2), BPF 116-2 (also referred to as BPF2), and DNC 117-2 (also referred to as DNC2) for the second communication.

Furthermore, for example, at least one processing of CP removing unit 120, FFT unit 121, and IDFT unit 123 may be omitted in accordance with a radio waveform of a received signal.

In FIG. 2, a reception signal output from duplexer 114 is input to LNA 115.

LNA 115 amplifies the reception signal input from duplexer 114.

BPF 116 performs filter processing of passing a desired band component on the signal input from LNA 115.

DNC 117 down-converts a frequency of the signal input from BPF 116 based on a signal input from LO supply unit 150.

LPF 118 performs LPF processing of passing a desired low frequency component of the signal input from DNC 117.

AD conversion unit 119 performs analogue-digital conversion on the signal input from LPF 118.

CP removing unit 120 removes the CP added to the signal input from AD conversion unit 119.

FFT unit 121 performs FFT processing (for example, conversion from a time component to a frequency component) on the signal input from CP removing unit 120.

Using the signal input from FFT unit 121, resource demapping unit 122 extracts a signal of a frequency resource (for example, a subcarrier or resource block) to which data is allocated.

IDFT unit 123 performs IDFT processing on the signal input from resource demapping unit 122.

Channel estimation unit 124 estimates a channel (propagation path) fluctuation by using, for example, a reference signal (for example, reference signal (RS)) included in the signal after the FFT.

MIMO reception processing unit 125 performs MIMO reception processing including channel equalization on the signal input from IDFT unit 123 on the basis of a channel estimation result input from channel estimation unit 124, for example, and detects each multiplexed stream signal. Note that, in a case where the MIMO transmission is not performed, the MIMO reception processing unit may perform the channel equalization and may not detect a stream signal.

Demodulation unit 126 converts a modulation symbol modulated by a modulation method such as QPSK or 16QAM into a bit string.

Decoding unit 127 performs decoding processing of a bit string encoded by an encoding method such as an LDPC code.

[Configuration Example of Communication Apparatus]

Next, a configuration example of communication apparatus 100 (for example, the terminal) will be described.

Note that the configuration (for example, encoding unit 101, modulation unit 102, precoding unit 103, DFT unit 104, resource mapping unit 105, IFFT unit 106, CP adding unit 107, and windowing processing unit 108 in the transmission unit, and CP removing unit 120, FFT unit 121, resource demapping unit 122, IDFT unit 123, channel estimation unit 124, MIMO reception processing unit 125, demodulation unit 126, and decoding unit 127 in the reception unit) of the baseband processing unit illustrated in FIG. 2 is an example, and the configuration is not limited thereto. For example, a part of the configuration of the baseband processing unit illustrated in FIG. 2 may not be included, and other configuration units may be included. In the drawings to be described later, an internal configuration of the baseband processing unit may be omitted.

### Configuration Example 1A

A configuration of communication apparatus 100 in configuration example 1A may be, for example, the configuration illustrated in FIG. 2.

(1) Configuration of the transmission unit: As illustrated in FIG. 2, for example, the baseband signal generated by the baseband processing unit is converted into an analogue signal by DA conversion unit 109, passes through LPF 110, and after that, is branched and input to UPC 111-1 (UPC1) and UPC 111-2 (UPC2).

As described above, in configuration example 1A illustrated in FIG. 2, for example, among the circuits that perform the transmission processing of communication apparatus 100, the circuits constituting the baseband processing unit, DA conversion unit 109, and LPF 110 may be common to the first communication and the second communication.

A frequency of the transmission signal input to UPC 111 (for example, UPC1 and UPC2) is converted into a frequency (for example, the transmission frequency) corresponding to each of the first communication and the second communication based on an LO signal supplied from LO supply unit 150 to be described later. The frequency-converted signal passes through BPF 112 (for example, BPF1 and BPF2) corresponding to each communication (or each frequency), is amplified by PA 113 (for example, PA1 and PA2), is output to an antenna side by duplexer 114, and is then radiated by an antenna (for example, antenna 1 and antenna 2) corresponding to each frequency.

(2) Configuration of the reception unit: As illustrated in FIG. 2, a signal received by each antenna (for example, antenna 1 and antenna 2) is output to each LNA 115 (for example, LAN1 and LNA2) by duplexer 114. The signal input to LNA 115 corresponding to each communication (or each frequency) is amplified, passes through BPF 116 (for example, BPF1 and BPF2), and is input to DNC 117 (for example, DNC1 and DNC2).

The reception signal input to each DNC 117 is converted into a frequency of the baseband signal on the basis of the LO signal supplied from LO supply unit 150 described later. The frequency-converted signal passes through LPF 118, is then converted into a digital signal by AD conversion unit 119, and is input to the baseband processing unit.

As described above, in configuration example 1A illustrated in FIG. 2, for example, among the circuits that perform the reception processing of communication apparatus 100, the circuits constituting the baseband processing unit, AD conversion unit 119, and LPF 118 may be common to the first communication and the second communication.

(3) Configuration of LO supply unit 150: As illustrated in FIG. 2, LO supply unit 150 supplies, for example, an LO signal corresponding to a frequency used for each communication to UPC 111 (UPC1 and UPC2) and DNC 117 (DNC1 and DNC2) corresponding to each communication (alternatively, each wireless communication band).

In configuration example 1A, for example, as illustrated in FIG. 2, LO 151-1 (also referred to as “LO1”) generates an LO signal corresponding to the frequency of the first communication, and supplies the LO signal to the UPC1 and the DNC1. Furthermore, LO 151-2 (also referred to as “LO2”) generates an LO signal corresponding to the frequency of the second communication, and supplies the LO signal to the UPC2 and the DNC2. For example, the LO1 corresponding to the first communication may supply the LO signal of a relatively high frequency (for example, a terahertz band or a 300 GHz band) to the UPC1 and the DNC1. Furthermore, for example, the LO2 corresponding to the second communication may supply the LO signal of a relatively low frequency (for example, millimeter wave band or 30 GHz band) to the UPC2 and the DNC2.

Control unit 152 may control the setting of enabling and disabling of each of the first communication and the second communication by controlling the LO1 and the LO2, for example. For example, control unit 152 may enable the LO1 when communication apparatus 100 (for example, the terminal) enables the first communication, and may enable the LO2 when communication apparatus 100 (for example, the terminal) enables the second communication. Furthermore, for example, control unit 152 may disable the LO1 when communication apparatus 100 (for example, the terminal) disables the first communication, and may disable the LO2 when communication apparatus 100 (for example, the terminal) disables the second communication.

In configuration example 1A, as illustrated in FIG. 2, LO 151 is independently provided for the first communication and the second communication. As a result, communication apparatus 100 can flexibly set the frequency by the LO signal for each of the first communication and the second communication. Furthermore, in configuration example 1A, since the first communication and the second communication can be enabled simultaneously, communication apparatus 100 can perform the first communication and the second communication simultaneously.

Furthermore, in configuration example 1A, since UPC 111 and DNC 117 are provided independently for each of the first communication and the second communication, for example, communication apparatus 100 does not need to operate UPC 111 and DNC 117 corresponding to the communication to be disabled. Therefore, the power consumption of communication apparatus 100 can be suppressed low.

### Configuration Example 1B

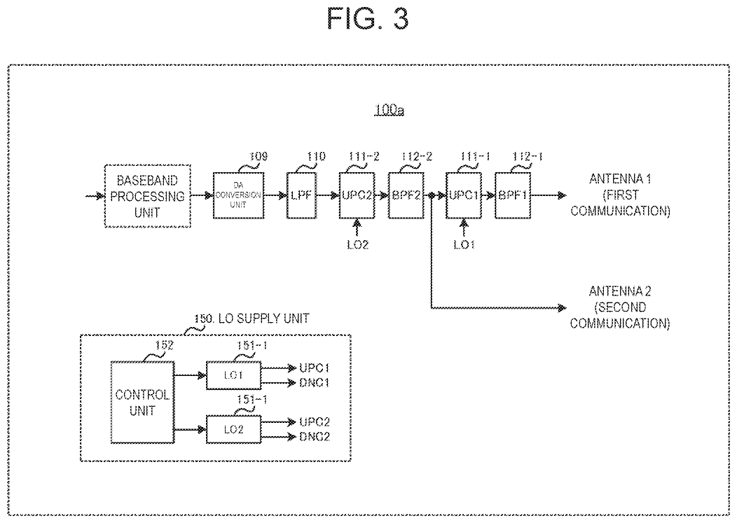

FIG. 3 is a block diagram illustrating a configuration example of communication apparatus 100a according to configuration example 1B. Note that, in FIG. 3, the reception unit, PA 113, and duplexer 114 of communication apparatus 100a are not illustrated.

In configuration example 1B, as illustrated in FIG. 3, similarly to configuration example 1A, among the circuits that perform transmission processing of communication apparatus 100a, the circuits constituting the baseband processing unit, DA conversion unit 109, and LPF 110 may be common to the first communication and the second communication.

Moreover, in configuration example 1B, as illustrated in FIG. 3, UPC 111-2 (UPC2) and BPF 112-2 (BPF2) corresponding to the second communication (or a radio frequency band corresponding to the second communication) may be shared by the first communication and the second communication.

For example, in communication apparatus 100a, the transmission signal after the LPF processing may be input to UPC 111-2 (UPC2) and converted into a frequency corresponding to the second communication. The signal converted into the frequency corresponding to the second communication may be branched and input into a processing unit (for example, UPC 111-1) corresponding to the first communication and a processing unit (for example, PA 113-2 (not illustrated)) corresponding to the second communication after passing through, for example, BPF 112-2 (BPF2).

One of the branched signals is emitted by an antenna corresponding to the second communication. Furthermore, the other of the branched signals may be input to UPC 111-1 and converted into a frequency corresponding to the first communication. The signal converted to the frequency corresponding to the first communication is emitted by an antenna corresponding to the first communication after passing through, for example, BPF 112-1.

In FIG. 3, similarly to configuration example 1A, LO supply unit 150 includes LO 151-1 (for example, LO1) that generates an LO signal corresponding to the first communication (alternatively, the radio frequency band of the first communication), and LO 151-2 (for example, LO2) that generates an LO signal corresponding to the second communication (alternatively, the radio frequency band of the second communication).

Furthermore, as in configuration example 1A, control unit 152 may control setting of enabling and disabling of each of the first communication and the second communication by controlling LO 151-1 (LO1) and LO 151-2 (LO2), for example.

For example, when communication apparatus 100a (for example, the terminal) enables both the first communication and the second communication, control unit 152 may enable both the LO1 and the LO2. Furthermore, for example, when communication apparatus 100a disables both the first communication and the second communication, control unit 152 may disable at least the LO2 or disable both the LO1 and the LO2.

Furthermore, for example, when communication apparatus 100a enables the first communication and disables the second communication, control unit 152 may enable both the LO1 and the LO2. Furthermore, for example, when communication apparatus 100a disables the first communication and enables the second communication, control unit 152 may disable the LO1 and enable the LO2.

In configuration example 1B, as illustrated in FIG. 3, LO 151 is independently provided for the first communication and the second communication. As a result, similarly to configuration example 1A, communication apparatus 100a can flexibly set the frequency by the LO signal for each of the first communication and the second communication. Furthermore, in configuration example 1B, since the first communication and the second communication can be enabled simultaneously, similarly to configuration example 1A, communication apparatus 100a can simultaneously perform the first communication and the second communication.

Furthermore, in configuration example 1B, the signal corresponding to the first communication is generated by two-stage up-conversion by UPC 111-2 and UPC 111-1. For example, UPC 111-1 may perform frequency conversion of a difference between the frequency corresponding to the first communication and the frequency corresponding to the second communication on the signal converted into the frequency corresponding to the second communication by UPC 111-2. For example, LO 151-1 may supply an LO signal having a frequency that is a difference between the frequency corresponding to the first communication and the frequency corresponding to the second communication to UPC 111-1.

As a result, the frequency of the LO signal supplied from LO 151-1 (LO1) to UPC 111-1 (UPC1) may be lower than that of configuration example 1A. Therefore, in configuration example 1B, communication apparatus 100a can be mounted by a simpler circuit than configuration example 1A.

Note that, in communication apparatus 100a, configuration units such as the baseband processing unit, AD conversion unit 119, LPF 118, DNC 117, and BPF 116 of the reception unit (not illustrated) may be common to the first communication and the second communication, similarly to the transmission unit of configuration example 1B.

### Configuration Example 2A

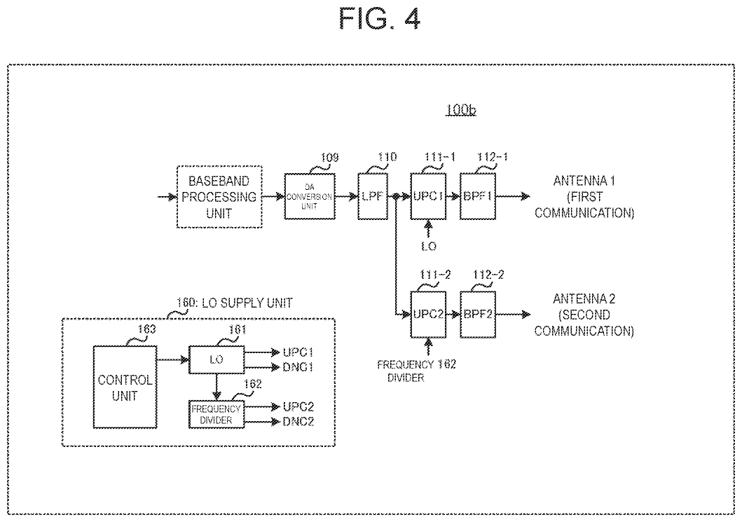

FIG. 4 is a block diagram illustrating a configuration example of communication apparatus 100b according to configuration example 2A. Note that, in FIG. 4, the reception unit, PA 113, and duplexer 114 of communication apparatus 100b are not illustrated.

In configuration example 2A, as illustrated in FIG. 4, similarly to configuration example 1A, among the circuits that perform transmission processing of communication apparatus 100b, the circuits constituting the baseband processing unit, DA conversion unit 109, and LPF 110 may be common to the first communication and the second communication.

As illustrated in FIG. 4, configuration example 2A may include LO supply unit 160. LO supply unit 160 may include, for example, LO 161 (For example, it is also referred to as LO), frequency divider 162, and control unit 163.

LO 161 generates, for example, an LO signal corresponding to a frequency used for the first communication, and supplies the LO signal to UPC 111-1 (UPC1). Furthermore, LO 161 outputs the LO signal to frequency divider 162.

For example, frequency divider 162 divides a frequency of the LO signal input from LO 161 (a frequency corresponding to the first communication) to generate a signal having a frequency corresponding to the second communication. Frequency divider 162 supplies the generated signal to UPC 111-2 (UPC2).

As described above, in configuration example 2A, communication apparatus 100b includes a single LO, the LO signal having the frequency corresponding to the first communication is supplied as it is to the UPC1, and the signal (signal having the frequency corresponding to the second communication) obtained by dividing the LO signal (LO output) by frequency divider 162 is supplied to the UPC2.

Control unit 163 may control the setting of enabling and disabling of each of the first communication and the second communication by controlling LO 161, for example. For example, when communication apparatus 100b (for example, the terminal) enables the first communication, control unit 163 may enable LO 161 to output the LO signal to UPC 111-1. Furthermore, for example, when communication apparatus 100b enables the second communication, control unit 163 may enable the output of the LO signal to frequency divider 162 by LO 161. Furthermore, for example, when communication apparatus 100b disables the first communication, control unit 163 may disable the output of the LO signal to UPC 111-1 by LO 161. Furthermore, for example, when communication apparatus 100b disables the second communication, control unit 163 may disable the output of the LO signal to frequency divider 162 by LO 161.

In configuration example 2A, for example, the number of LOs to be mounted (for example, one) is smaller than that in configuration example 1A (for example, two). Furthermore, in configuration example 2A, frequency divider 162 having a simpler configuration than the LO is mounted instead of reducing the number of LOs. As a result, in configuration example 2A, the complexity (for example, circuit scale) in the implementation of communication apparatus 100b can be reduced as compared with configuration example 1A. Furthermore, in configuration example 2A, similarly to configuration example 1A, since the first communication and the second communication can be enabled at the same time, communication apparatus 100b can perform the first communication and the second communication at the same time.

Furthermore, in configuration example 2A, since UPC 111 is provided independently for each of the first communication and the second communication, for example, communication apparatus 100b does not need to operate UPC 111 corresponding to the communication to be disabled. Therefore, the power consumption of communication apparatus 100 can be suppressed low.

Note that, in communication apparatus 100b, configuration units such as the baseband processing unit, AD conversion unit 119, and LPF 118 of the reception unit (not illustrated) may be common to the first communication and the second communication, similarly to the transmission unit of configuration example 2A. Furthermore, in communication apparatus 100b, the LO signal having the frequency corresponding to the first communication may be supplied from LO 161 to DNC 117-1 corresponding to the first communication, and the signal having the frequency corresponding to the second communication may be supplied from frequency divider 162 to DNC 117-2 corresponding to the second communication.

### Configuration Example 2B

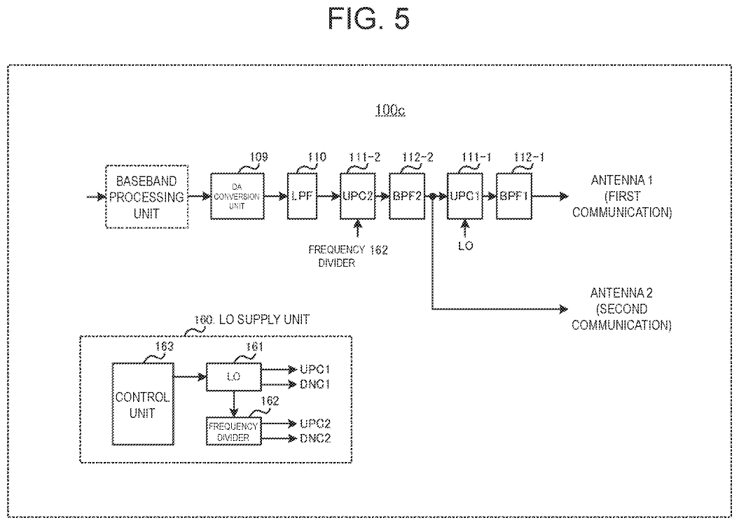

FIG. 5 is a block diagram illustrating a configuration example of communication apparatus 100c according to configuration example 2B. Note that, in FIG. 5, the reception unit, PA 113, and duplexer 114 of communication apparatus 100c are not illustrated.

In configuration example 2B, as illustrated in FIG. 5, similarly to configuration example 2A, among the circuits that perform transmission processing of communication apparatus 100c, the circuits constituting the baseband processing unit, DA conversion unit 109, and LPF 110 may be common to the first communication and the second communication.

In configuration example 2B, as illustrated in FIG. 5, similarly to configuration example 1B, UPC 111-2 (UPC2) and BPF 112-2 (BPF2) corresponding to the second communication (or a radio frequency band corresponding to the second communication) may be shared by the first communication and the second communication.

Furthermore, in configuration example 2B, similarly to configuration example 2A, communication apparatus 100c may include single LO 161 and single frequency divider 162. For example, an LO signal having the frequency corresponding to the first communication is supplied as it is to the UPC1, and a signal (signal having the frequency corresponding to the second communication) obtained by dividing the LO signal (LO output) by frequency divider 162 is supplied to the UPC2.

Control unit 163 may control the setting of enabling and disabling of each of the first communication and the second communication by controlling LO 161, for example.

For example, when communication apparatus 100c (for example, the terminal) enables both the first communication and the second communication, control unit 163 may enable LO 161 to output the LO signal to both the UPC1 and frequency divider 162. Furthermore, for example, when communication apparatus 100c disables both the first communication and the second communication, control unit 163 may disable at least the output of the LO signal to frequency divider 162 by LO 161, or may disable the output of the LO signal to both the UPC1 and frequency divider 162 by LO 161.

Furthermore, for example, when communication apparatus 100c enables the first communication and disables the second communication, control unit 163 may enable LO 161 to output the LO signal to both the UPC1 and frequency divider 162. Furthermore, for example, when communication apparatus 100c disables the first communication and enables the second communication, control unit 163 may enable the output of the LO signal to frequency divider 162 by LO 161 and disable the output of the LO signal to the UPC1 by LO 161.

In configuration example 2B, for example, the number of LOs to be mounted (for example, one) is smaller than that in configuration example 1B (for example, two). Furthermore, in configuration example 2B, frequency divider 162 having a simpler configuration than the LO is mounted instead of reducing the number of LOs. As a result, in configuration example 2B, the complexity (for example, circuit scale) in the implementation of communication apparatus 100c can be reduced as compared with configuration example 1B. Furthermore, in configuration example 2B, similarly to configuration example 1B, since the first communication and the second communication can be enabled at the same time, communication apparatus 100c can perform the first communication and the second communication at the same time.

Furthermore, in configuration example 2B, the signal corresponding to the first communication is generated by two-stage up-conversion by UPC 111-2 and UPC 111-1. For example, UPC 111-1 may perform frequency conversion of a difference between the frequency corresponding to the first communication and the frequency corresponding to the second communication on the signal converted into the frequency corresponding to the second communication by UPC 111-2. For example, LO 161 may supply an LO signal having a frequency that is a difference between the frequency corresponding to the first communication and the frequency corresponding to the second communication to UPC 111-1.

As a result, the frequency of the LO signal supplied from LO 161 (LO) to UPC 111-1 (UPC1) may be lower than that of configuration example 2A. Therefore, in configuration example 2B, communication apparatus 100c can be mounted by a simpler circuit than configuration example 2A.

Note that, in communication apparatus 100c, configuration units such as the baseband processing unit, AD conversion unit 119, LPF 118, DNC 117, and BPF 116 of the reception unit (not illustrated) may be common to the first communication and the second communication, similarly to the transmission unit of configuration example 2B. Furthermore, in communication apparatus 100c, the LO signal having the frequency corresponding to the first communication may be supplied from LO161 to DNC 117-1 corresponding to the first communication, and the signal having the frequency corresponding to the second communication may be supplied from frequency divider 162 to DNC 117-2 corresponding to the second communication.

Furthermore, in configuration example 2A and configuration example 2B, the case of using the frequency divider has been described, but the present disclosure is not limited thereto, and for example, a multiplier may be used instead of the frequency divider. When a multiplier is used, the output of the LO may be directly supplied to the UPC2 and the DNC2, and an output of the multiplier may be supplied to the UPC1 and the DNC1. As a result, the output frequency of the LO can be suppressed to be low, and the complexity in the implementation of communication apparatus 100b or communication apparatus 100c can be reduced.

### Configuration Example 3

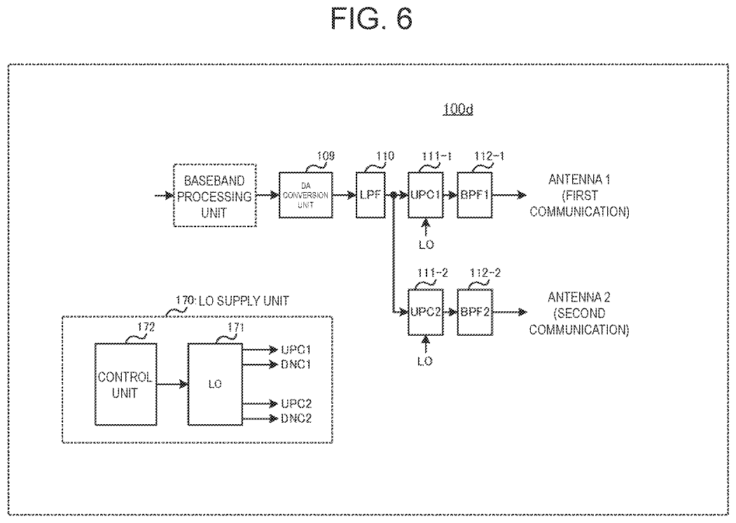

FIG. 6 is a block diagram illustrating a configuration example of communication apparatus 100d according to configuration example 3. Note that, in FIG. 6, the reception unit, PA 113, and duplexer 114 of communication apparatus 100d are not illustrated.

In configuration example 3, as illustrated in FIG. 6, similarly to configuration example 1A and configuration example 2A, among the circuits that perform transmission processing of communication apparatus 100d, the baseband processing unit, DA conversion unit 109, and LPF 110 may be common to the first communication and the second communication.

In configuration example 3, as illustrated in FIG. 6, LO supply unit 170 may be provided. LO supply unit 170 may include, for example, LO 171 (For example, it is also referred to as LO) and control unit 172.

For example, LO 171 may generate an LO signal corresponding to a frequency used for the first communication, supply the LO signal to UPC 111-1 (UPC1), generate an LO signal corresponding to a frequency used for the second communication, and supply the LO signal to UPC 111-2 (UPC2). For example, LO 171 may switch and output the LO signal corresponding to the first communication and the LO signal corresponding to the second communication in accordance with an instruction of control unit 172.

Thus, configuration example 3 includes single LO. Furthermore, LO 171 supports outputs of the plurality of frequencies.

Control unit 172 may control the setting of enabling and disabling of each of the first communication and the second communication by controlling LO 171, for example. For example, when communication apparatus 100d (for example, the terminal) enables the first communication, control unit 172 may enable LO 171 to output the LO signal to UPC 111-1. Furthermore, for example, when communication apparatus 100d enables the second communication, control unit 172 may enable LO 171 to output the LO signal to UPC 111-2. Furthermore, for example, when communication apparatus 100d disables the first communication, control unit 172 may disable the output of the LO signal to UPC 111-1 by LO 171. Furthermore, for example, when communication apparatus 100d disables the second communication, control unit 172 may disable the output of the LO signal to UPC 111-2 by LO 171.

As described above, in configuration example 3, LO supply unit 170 may supply the LO signal of the frequency corresponding to one of the first communication and the second communication by single LO 171.

In configuration example 3, for example, the number of LOs to be mounted (for example, one) is smaller than those in configuration example 1A and configuration example 1B (for example, two). As a result, in configuration example 3, the complexity (for example, circuit scale) in the implementation of communication apparatus 100d can be reduced as compared with configuration example 1A and configuration example 1B.

Furthermore, according to configuration example 3, for example, as compared with configuration example 2A and configuration example 2B, it is not necessary to mount the frequency divider, and thus, it is possible to reduce the complexity in mounting communication apparatus 100d.

Note that, in communication apparatus 100d, configuration units such as the baseband processing unit, AD conversion unit 119, and LPF 118 of the reception unit (not illustrated) may be common to the first communication and the second communication, similarly to the transmission unit of configuration example 3. Furthermore, in communication apparatus 100d, the LO signal having the frequency corresponding to the first communication may be supplied from LO 171 to DNC 117-1 corresponding to the first communication, and the signal having the frequency corresponding to the second communication may be supplied from LO 171 to DNC 117-2 corresponding to the second communication.

The configuration examples of communication apparatus 100 and the examples of controlling the enabling and disabling of the first communication and the second communication have been described above. Note that the configuration of communication apparatus 100 is not limited to the above-described configuration examples, and may be another configuration.

Next, an operation example related to setting of enabling and disabling of the first communication and the second communication by communication apparatus 100 (for example, control unit 152) will be described.

For example, communication apparatus 100 may set enabling and disabling of each of the first communication and the second communication in accordance with a condition. Then, communication apparatus 100 may perform the first communication and the second communication in accordance with the setting of the enabling and the disabling.

Operation examples 1 to 6 of communication apparatus 100 will be described below.

Note that control unit 152 of communication apparatus 100a, control unit 163 of communication apparatus 100b or 100c, and control unit 172 of communication apparatus 100d may also perform control in a similar manner to the following operation examples.

### Operation Example 1

In operation example 1, the above-described condition may be based on a parameter related to wireless communication set in communication apparatus 100.

For example, communication apparatus 100 (for example, the terminal) may set enabling and disabling of each of the first communication (for example, wireless communication using a terahertz band) and the second communication (for example, wireless communication using a millimeter wave band) in accordance with a value of the parameter of the wireless communication.

Here, examples of the parameter of the wireless communication include a communication bandwidth, a waveform (radio waveform), transmission power, a subcarrier spacing (SCS), a symbol length, a modulation multilevel number, and a coding rate. Note that the parameters of the wireless communication are not limited to these parameters, and may be other parameters.

For example, communication apparatus 100 may set the enabling of the first communication when the communication bandwidth is wider than a threshold value. As a result, communication apparatus 100 can perform high-speed communication effectively using a relatively wide bandwidth in the terahertz band. On the other hand, communication apparatus 100 may set the enabling of the second communication when the communication bandwidth is narrower than the threshold value. As a result, communication apparatus 100 can perform communication suitable for a relatively narrow bandwidth in the millimeter wave band.

Furthermore, for example, communication apparatus 100 may set the enabling of the first communication in a case where the waveform is DFT-s-OFDM. As a result, communication apparatus 100 can perform communication that makes use of the characteristic that “the maximum transmission power is relatively high” of DFT-s-OFDM and that compensates for the characteristic of terahertz band communication with large attenuation. On the other hand, for example, communication apparatus 100 may set the enabling of the second communication when the waveform is CP-OFDM. As a result, communication apparatus 100 can perform communication in which the characteristic of the millimeter wave band having a relatively large influence of a delay wave is supplemented by making use of the characteristic of “having relatively high resistance to the delay wave” of the CP-OFDM.

Note that the OFDM is an abbreviation for orthogonal frequency division multiplexing, and the DFT-s-OFDM is an abbreviation for discrete Fourier transform-spread-OFDM. Furthermore, the DFT-s-OFDM may also be referred to as single carrier-frequency division multiple access (SC-FDMA). Furthermore, instead of the OFDM, another waveform corresponding to multi-carrier transmission may be used. Furthermore, instead of the DFT-s-OFDM, another waveform corresponding to single carrier transmission may be used.

Furthermore, for example, communication apparatus 100 may set the enabling of the first communication in a case where the transmission power is greater than or equal to a threshold value. As a result, communication apparatus 100 can perform communication in which the characteristics of the terahertz band with high attenuation are compensated for by the transmission power. On the other hand, for example, communication apparatus 100 may set the enabling of the second communication in a case where the transmission power is less than the threshold value. Since attenuation is small in the millimeter wave band, reduction in reception power can be suppressed even if transmission power of communication apparatus 100 is small.

Furthermore, for example, communication apparatus 100 may set the enabling of the first communication in a case where the SCS is greater than or equal to a threshold value (for example, 120 kHz) or in a case where the symbol length (or CP length) is less than or equal to a threshold value. As a result, communication apparatus 100 can perform communication that compensates for the characteristics of the terahertz band in which the influence of phase noise is relatively large. On the other hand, for example, communication apparatus 100 may set the enabling of the second communication in a case where the SCS is narrower than a threshold value (for example, 120 kHz) or in a case where the symbol length (or CP length) is longer than a threshold value. As a result, communication apparatus 100 can perform communication that compensates for the characteristics of the millimeter wave band having a relatively large influence of the delay wave.

Furthermore, for example, communication apparatus 100 may set the enabling of the first communication in a case where the modulation multilevel number is less than or equal to a threshold value (for example, 4) or in a case where the coding rate is less than or equal to a threshold value. As a result, communication apparatus 100 can effectively utilize a relatively wide bandwidth in the terahertz band and perform high-speed communication with a low coding rate. On the other hand, for example, communication apparatus 100 may set the enabling of the second communication in a case where the modulation multilevel number is higher than a threshold value (for example, 4) or in a case where the coding rate is higher than a threshold value. As a result, communication apparatus 100 can perform communication suitable for a relatively narrow bandwidth in the millimeter wave band, for example, a high coding rate.

Note that communication apparatus 100 may set the disabling of the first communication in a case where the condition regarding the setting of the enabling of the first communication described above is not satisfied. Similarly, communication apparatus 100 may set the disabling of the second communication in a case where the condition regarding the setting of the enabling of the second communication is not satisfied.

### Operation Example 2

In operation example 2, the above-described condition may be based on a propagation characteristic (alternatively, a propagation environment) of communication apparatus 100.

For example, communication apparatus 100 may set enabling and disabling of each of the first communication (for example, wireless communication using a terahertz band) and the second communication (for example, wireless communication using a millimeter wave band) in accordance with the propagation characteristic.

The propagation characteristic of communication apparatus 100 may be, for example, whether or not communication in communication apparatus 100 is a line of sight environment (LOS), or may be an influence of a delay wave in communication apparatus 100 (for example, a delay amount of a delay wave of communication or a delay spread amount of a delay wave).

For example, communication apparatus 100 may set a communication partner (for example, a relay device) in the first communication to enable the first communication in a case of a line of sight environment (LOS). As a result, communication apparatus 100 can perform communication that compensates for the characteristics of the terahertz band with large attenuation. On the other hand, for example, in a case where the line of sight environment is not for the communication partner (for example, a relay device) in the first communication (for example, a non-line of sight (NLOS) environment), communication apparatus 100 may set the enabling of the second communication. As a result, since attenuation is small in the millimeter wave band, it is possible to suppress a decrease in reception power of a signal transmitted from communication apparatus 100 even in a case where it is not a line of sight environment.

Note that communication apparatus 100 may set the disabling of the first communication, for example, in a case of a non-line of sight environment. Furthermore, for example, in a case of a line of sight environment, communication apparatus 100 may set the enabling of the second communication or may set the disabling of the second communication.

Furthermore, for example, in a case where the influence of the delay wave is large (for example, in a case where the delay amount or the delay spread amount of the delay wave is more than or equal to a threshold value), communication apparatus 100 may set the enabling of the first communication. As a result, communication apparatus 100 can perform communication using the terahertz band that is hardly affected by the delayed wave. On the other hand, for example, in a case where the influence of the delay wave is small (for example, in a case where the delay amount or the delay spread amount of the delay wave is less than the threshold value), communication apparatus 100 may set the enabling of the second communication. As a result, communication apparatus 100 can perform communication in the millimeter wave band with small attenuation.

Note that communication apparatus 100 may set the disabling of the first communication or set the enabling of the first communication in a case where the influence of the delay wave is small. Furthermore, communication apparatus 100 may set the disabling of the second communication, for example, in a case where the influence of the delay wave is large.

### Operation Example 3

In operation example 3, the above-described condition may be based on directivity (alternatively, directivity of a beam) of the antenna in communication apparatus 100.

Communication apparatus 100 may set enabling and disabling of the first communication (for example, wireless communication using a terahertz band) and the second communication (for example, wireless communication using a millimeter wave band) in accordance with the directivity of the transmission antenna or the reception antenna, for example.

For example, in a case where the directivity of the transmission antenna or the reception antenna is present or strong (for example, when the beam is thin), the first communication may be enabled. As a result, reception power is improved by strong directivity, and communication apparatus 100 can perform communication that compensates for the characteristics of the terahertz band with large attenuation.

On the other hand, when there is no or weak directivity of the transmission antenna or the reception antenna (for example, when the beam is thick), the second communication may be enabled. As a result, communication apparatus 100 can perform communication in the millimeter wave band with less attenuation.

Note that the antenna directivity may be expressed as an antenna gain. For example, communication apparatus 100 may determine that the antenna directivity is strong when the antenna gain is greater than or equal to a threshold value, and may determine that the antenna directivity is weak when the antenna gain is less than the threshold value.

Furthermore, for example, communication apparatus 100 may set the disabling of the first communication in a case where there is no or weak directivity of the transmission antenna or the reception antenna, and may set the disabling of the second communication in a case where there is or strong directivity of the transmission antenna or the reception antenna.

### Operation Example 4

In operation example 4, the above condition may be based on a result of carrier sensing in an unlicensed band (or referred to as shared spectrum).

For example, communication apparatus 100 may set enabling and disabling of each of the first communication (for example, wireless communication using a terahertz band) and the second communication (for example, wireless communication using a millimeter wave band) in accordance with a result of carrier sensing in the unlicensed band.

Note that the carrier sensing is also referred to as, for example, listen before talk (LBT) or channel clear assessment (CCA).

For example, communication apparatus 100 may perform carrier sensing in both a terahertz band that is an unlicensed band and a millimeter wave band that is an unlicensed band. Communication apparatus 100 may set, for example, the enabling of communication corresponding to a radio frequency band determined to be usable by the carrier sensing among the terahertz band corresponding to the first communication and the millimeter wave band corresponding to the second communication.

For example, in a case where it is determined that a certain band in the terahertz band is available (For example, it is not idle or busy) as a result of the carrier sensing, control unit 152 may set the enabling of the first communication. Alternatively, for example, in a case where it is determined that a certain band in the millimeter wave band is available as a result of the carrier sensing, control unit 152 may set the enabling of the second communication. As a result, communication apparatus 100 can perform communication in a band in which interference by other wireless communication devices is small.

On the other hand, for example, in a case where control unit 152 determines that a certain band in the terahertz band is not available (for example, busy) as a result of the carrier sensing, the control unit may set the disabling of the first communication. Alternatively, for example, in a case where it is determined that a certain band in the millimeter wave band is not available as a result of the carrier sensing, control unit 152 may set the disabling of the second communication. As a result, it is possible to prevent interference that a signal transmitted from communication apparatus 100 gives to another wireless communication device.

Note that communication apparatus 100 may set, for example, the disabling of communication corresponding to a radio frequency band determined to be unusable by the carrier sensing.

### Operation Example 5

In operation example 5, the above-described condition may be based on an instruction from a base station to communication apparatus 100 (for example, the terminal).

Communication apparatus 100 (for example, the terminal) may set enabling and disabling of each of the first communication (for example, wireless communication using a terahertz band) and the second communication (for example, wireless communication using a millimeter wave band) in accordance with, for example, an instruction given (or notified) from the base station.

For example, the instruction given from the base station to communication apparatus 100 (for example, the terminal) may be an explicit instruction. For example, a control signal provided from the base station to communication apparatus 100 may explicitly instruct setting of the enabling and disabling of at least one of the first communication and the second communication. Note that the control signal may be, for example, at least one of radio resource control (RRC), medium access control (MAC), and downlink control information (DCI).

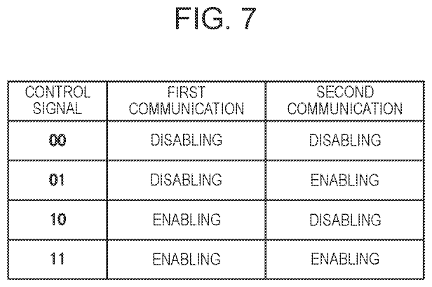

For example, as illustrated in FIG. 7, the control signal may be given in two bits, each bit corresponding to a combination of the enabling and disabling of the first communication and the second communication.

In operation example 5, since the selection of the type of communication (for example, the first communication and the second communication) performed by communication apparatus 100 (for example, the terminal) is determined by the base station, communication apparatus 100 does not need to determine the selection of the communication type, and a processing amount (for example, a calculation amount) in communication apparatus 100 can be reduced.

Alternatively, the instruction given from the base station to communication apparatus 100 (for example, the terminal) may be an implicit instruction. For example, other values such as a parameter (for example, communication bandwidth, waveform, SCS, symbol length, MCS, transmission power, and the like) of wireless communication instructed by a control signal provided from the base station to communication apparatus 100, a propagation environment, directivity of a transmission or reception antenna, and a result of carrier sensing may be associated with the setting of the enabling and disabling of the first communication and the second communication. As a result, the overhead of the control signal for notifying the selection of the communication type can be reduced.

### Operation Example 6

In operation example 6, communication apparatus 100 (for example, the terminal) may set enabling and disabling of each of the first communication (for example, wireless communication using a terahertz band) and the second communication (for example, wireless communication using a millimeter wave band) on the basis of, for example, one or more of the “parameter of radio communication”, the “propagation characteristic”, the “result of carrier sensing”, the “directivity of transmission or reception antenna”, and the “instruction by the base station or other information” described in operation examples 1 to 5.

For example, functions such as artificial intelligence (AI), machine learning, artificial neural network (ANN), and deep learning may be used to determine whether to enable or disable the first communication and the second communication. As a result, communication apparatus 100 can determine (or selection, setting) an optimal communication method on the basis of various conditions.

### Other Operation Examples

Note that the conditions described in operation example 1 to 6 described above are examples, and the operation related to the setting of the enabling and disabling of the first communication and the second communication is not limited thereto.

For example, communication apparatus 100 may set the enabling of the second communication on the basis of the condition of “setting the enabling of the first communication” described above, or may set the enabling of the first communication on the basis of the condition of “setting the enabling of the second communication” described above.

Furthermore, for example, contrary to the operation example described above, communication apparatus 100 may control “the parameter of the wireless communication or the directivity of the transmission or reception antenna” under the condition of “performing the first communication” or “performing the second communication”.

For example, when performing the first communication, communication apparatus 100 may set a wide communication bandwidth, may set a waveform to DFT-s-OFDM, may set a large transmission power, or may set a strong transmission or reception antenna directivity. As a result, even in the terahertz band with relatively strong attenuation, the reception power for the signal of communication apparatus 100 is improved, and the communication quality is improved.

Alternatively, for example, when performing the first communication, communication apparatus 100 may set a wide SCS. As a result, even in the terahertz band where the influence of phase noise is relatively large, communication apparatus 100 can perform communication while suppressing the influence of the phase noise.

Furthermore, for example, in a case where the second communication is performed, communication apparatus 100 may set a long slot length or CP length. As a result, communication apparatus 100 can perform communication while suppressing the influence of the delay wave even in the millimeter wave band in which the influence of the delay wave is relatively large. Furthermore, for example, time required for processing of each slot becomes long, and the processing speed can be suppressed to be low.

Alternatively, for example, in a case where the second communication is performed, communication apparatus 100 may set weak directivity of the transmission or reception antenna. As a result, control of the transmission or reception antenna becomes relatively easy, and implementation of communication apparatus 100 becomes easy.

An operation example related to the setting of the enabling and disabling of the first communication and the second communication by communication apparatus 100 has been described above.

As described above, in the present exemplary embodiment, communication apparatus 100 sets the enabling and disabling of each of the first communication (for example, communication using the first radio frequency band) and the second communication (for example, communication using a second radio frequency band that is lower than the first radio frequency band) in accordance with the condition. As a result, communication apparatus 100 can improve throughput and coverage performance by communication in a radio frequency band in accordance with the condition. Therefore, according to the present exemplary embodiment, the performance of wireless communication can be improved.

Furthermore, in communication apparatus 100, for example, some circuits used for the first communication and the second communication are made common. Therefore, according to the present exemplary embodiment, communication apparatus 100 does not need to include, for example, an individual processing unit in the radio frequency band, the configuration can be simplified, and the manufacturing cost or the circuit scale of communication apparatus 100 (for example, the terminal) can be reduced.

The exemplary embodiment of the present disclosure has been described above.

Note that, in the above-described exemplary embodiment, examples have been described in which control unit 152 sets the enabling and disabling of the first communication and the second communication by controlling the local oscillator (LO). In the non-limiting exemplary embodiment of the present disclosure, as another example, control unit 152 may set the enabling and disabling of each communication by controlling another circuit (for example, a converter, an amplifier, a phased array, an antenna, a frequency divider, or the like) corresponding to each communication.

Furthermore, in the above-described exemplary embodiment, when one of the first communication and the second communication is enabled, the other communication may be disabled. Alternatively, both the first communication and the second communication may be enabled.

Furthermore, in the above-described exemplary embodiment, the method in which communication apparatus 100 supports two communications corresponding to two frequency bands has been described, but the types of communication supported by communication apparatus 100 are not limited to two types. For example, an operation similar to that of the above-described exemplary embodiment may be applied to a method corresponding to three or more types of communication corresponding to three or more types of frequency bands. The frequency band may be, for example, an operating band (n1, n2, or the like) described in 3GPP TS38.104 V17.4.0.

Furthermore, in the above-described exemplary embodiment, an example has been described in which some of the circuits corresponding to the first communication and the second communication are made common, but the present disclosure is not limited thereto. For example, a circuit corresponding to the first communication and a circuit corresponding to the second communication may not be made common, and may be provided independently. In this case, communication apparatus 100 may set the enabling and disabling of the first communication and the second communication according to any one of the operation examples described above.

Furthermore, the millimeter wave band may be read as a frequency of “frequency range 2 (FR2)”. The sub 6 GHz band may be read as a frequency of “frequency range 1 (FR1)”.

The radio frequency may also be referred to as a carrier frequency.

Although the terahertz band and the millimeter wave band have been described as examples of the radio frequency band, the present disclosure is not limited thereto, and the frequency band used for transmission or reception in communication apparatus 100 may be another frequency band or a combination of other frequency bands.

The base station may be referred to as a gNodeB or a gNB. Furthermore, the terminal may be referred to as UE.

Furthermore, in the above exemplary embodiment, the notation “unit” used for each component may be replaced with another notation such as “circuit (circuitry)”, “device”, or “module”.

The present disclosure can be realized by software, hardware, or software in cooperation with hardware. Each functional block used in the description of each embodiment described above can be partly or entirely realized by an LSI such as an integrated circuit, and each process described in each embodiment may be controlled partly or entirely by the same LSI or a combination of LSIs. The LSI may be individually formed as chips, or one chip may be formed so as to include a part or all of the functional blocks. The LSI may include a data input and output coupled thereto. The LSI here may be referred to as an IC, a system LSI, a super LSI, or an ultra LSI depending on a difference in the degree of integration.

However, the technique of implementing an integrated circuit is not limited to the LSI and may be realized by using a dedicated circuit, a general-purpose processor, or a special-purpose processor. In addition, a Field Programmable Gate Array (FPGA) that can be programmed after the manufacture of the LSI or a reconfigurable processor in which the connections and the settings of circuit cells disposed inside the LSI can be reconfigured may be used. The present disclosure can be realized as digital processing or analogue processing.

If future integrated circuit technology replaces LSIs as a result of the advancement of semiconductor technology or other derivative technology, the functional blocks could be integrated using the future integrated circuit technology. Biotechnology can also be applied.

The present disclosure can be realized by any kind of apparatus, device or system having a function of communication, which is referred as a communication apparatus. The communication apparatus may include a radio transceiver (transceiver) and a processing or control circuit. The radio transceiver may include a receiver and a transmitter, or include receiving and transmitting functions. The radio transceiver (the transmission unit and the reception unit) may include a radio frequency (RF) module and one or more antennas. The RF module may include an amplifier, and an RF modulator and demodulator, or the like. Some non-limiting examples of such communication apparatus include a phone (e.g., cellular (cell) phone, smart phone), a tablet, a personal computer (PC) (e.g., laptop, desktop, notebook), a camera (e.g., digital still/video camera), a digital player (digital audio/video player), a wearable device (e.g., wearable camera, smart watch, tracking device), a game console, a digital book reader, a telehealth/telemedicine (remote health and medicine) device, and a vehicle providing communication functionality (e.g., automotive, airplane, ship), and various combinations thereof.

The communication apparatus is not limited to be portable or movable, and may also include any kind of apparatus, device or system being non-portable or stationary, such as a smart home device (e.g., an appliance, lighting, smart meter, control panel), a vending machine, and any other “things” in a network of an “Internet of Things (IoT)”.

The communication may include exchanging data through, for example, a cellular system, a wireless LAN system, a satellite system, etc., and various combinations thereof.

The communication apparatus may comprise a device such as a controller or a sensor which is coupled to a communication device performing a function of communication described in the present disclosure. For example, the communication apparatus may comprise a controller or a sensor that generates control signals or data signals which are used by a communication device performing a communication function of the communication apparatus.

The communication apparatus also may include an infrastructure facility, such as a base station, an access point, and any other apparatus, device or system that communicates with or controls apparatuses such as those in the above non-limiting examples.

A communication apparatus according to an exemplary embodiment of the present disclosure includes: control circuitry which, in operation, in accordance with a condition, makes a setting of enabling or disabling of first communication using a first radio frequency band and makes a setting of enabling or disabling of second communication using a second radio frequency band lower than the first radio frequency band; and communication circuitry which, in operation, performs the first communication or the second communication in accordance with the setting of the enabling or disabling of the first communication and the setting of the enabling or disabling of the second communication.

In an exemplary embodiment of the present disclosure, the condition is based on a parameter related to wireless communication set in the communication apparatus.

In an exemplary embodiment of the present disclosure, the parameter includes at least one of a communication bandwidth, a radio waveform, transmission power, a subcarrier spacing, a symbol length, or a modulation and coding scheme.

In an exemplary embodiment of the present disclosure, the condition is based on a propagation characteristic of the communication apparatus.

In an exemplary embodiment of the present disclosure, the propagation characteristic is whether or not communication in the communication apparatus is a line of sight environment, and the control circuitry makes the setting of the enabling of the first communication in a case of the line of sight environment, and makes the setting of the enabling of the second communication in a case of not the line of sight environment.

In an exemplary embodiment of the present disclosure, the propagation characteristic is a delay amount or a delay spread amount of a delay wave of communication in the communication apparatus, and the control circuitry makes the setting of the enabling of the first communication when the delay amount or the delay spread amount is greater than or equal to a threshold value, and makes the setting of the enabling of the second communication when the delay amount or the delay spread amount is less than the threshold value.

In an exemplary embodiment of the present disclosure, the condition is based on directivity of an antenna in the communication apparatus, and the control circuitry makes the setting of the enabling of the first communication when there is the directivity and makes the setting of the enabling of the second communication when there is no directivity.

In an exemplary embodiment of the present disclosure, the condition is based on a result of carrier sensing, and in accordance with a radio frequency band determined to be usable by the carrier sensing, out of the first radio frequency band and the second radio frequency band, the control circuitry makes the setting of the enabling of the first communication or the setting of the enabling of the second communication.

In an exemplary embodiment of the present disclosure, the communication apparatus is a terminal, and the condition is based on an instruction from a base station.

In an exemplary embodiment of the present disclosure, the communication apparatus is a terminal, and the condition is based on at least one of a parameter related to wireless communication set in the communication apparatus, a propagation characteristic of the communication apparatus, directivity of an antenna in the communication apparatus, a result of carrier sensing, or an instruction from a base station.

In an exemplary embodiment of the present disclosure, wherein the control circuitry includes baseband processing circuitry which, in operation, performs baseband processing, the baseband processing circuitry being common to the first communication and the second communication.

In an exemplary embodiment of the present disclosure, wherein the control circuitry includes a first local oscillator which, in operation, generates a signal corresponding to the first radio frequency band and a second local oscillator which, in operation, generates a signal corresponding to the second radio frequency band.

In an exemplary embodiment of the present disclosure, the control circuitry includes: a first local oscillator which, in operation, generates a first signal corresponding to the first radio frequency band; and a second local oscillator which, in operation, generates a second signal corresponding to the second radio frequency band, the communication circuitry includes an up-converter corresponding to the second radio frequency band, the upconverter being common to the first communication and the second communication, and the first signal corresponds to a frequency equal to a difference in frequency between the first radio frequency band and the second radio frequency band.

In an exemplary embodiment of the present disclosure, the control circuitry includes a local oscillator which, in operation, generates a first signal corresponding to the first radio frequency band, and a frequency divider which, in operation, divides a frequency of the first signal to generate a second signal corresponding to the second radio frequency band.

In an exemplary embodiment of the present disclosure, the control circuitry includes: a local oscillator which, in operation, generates a first signal corresponding to the first radio frequency band; and a frequency divider which, in operation, divides a frequency of the first signal to generate a second signal corresponding to the second radio frequency band, the communication circuitry includes an up-converter corresponding to the second radio frequency band, the upconverter being common to the first communication and the second communication, and the first signal corresponds to a frequency equal to a difference in frequency between the first radio frequency band and the second radio frequency band.

In an exemplary embodiment of the present disclosure, the control circuitry includes a local oscillator which, in operation, switches between outputting a signal corresponding to the first radio frequency band and outputting a signal corresponding to the second radio frequency band.

A communication method according to an exemplary embodiment of the present disclosure, which is performed by a communication apparatus, includes: in accordance with a condition, making a setting of enabling or disabling of first communication using a first radio frequency band and making a setting of enabling or disabling of second communication using a second radio frequency band lower than the first radio frequency band; and performing the first communication or the second communication in accordance with the setting of the enabling or disabling of the first communication and the setting of the enabling or disabling of the second communication.

An aspect of the present disclosure is useful for a wireless communication system.

What is claimed is:

1. A communication apparatus comprising:
control circuitry which, in operation, in accordance with a condition, makes a setting of enabling or disabling of first communication using a first radio frequency band and makes a setting of enabling or disabling of second communication using a second radio frequency band lower than the first radio frequency band; and
communication circuitry which, in operation, performs the first communication or the second communication in accordance with the setting of the enabling or disabling of the first communication and the setting of the enabling or disabling of the second communication.

2. The communication apparatus according to claim 1, wherein the condition is based on a parameter related to wireless communication set in the communication apparatus.

3. The communication apparatus according to claim 2, wherein the parameter includes at least one of a communication bandwidth, a radio waveform, transmission power, a subcarrier spacing, a symbol length, or a modulation and coding scheme.

4. The communication apparatus according to claim 1, wherein the condition is based on a propagation characteristic of the communication apparatus.

5. The communication apparatus according to claim 4, wherein
the propagation characteristic is whether or not communication in the communication apparatus is a line of sight environment, and
the control circuitry makes the setting of the enabling of the first communication in a case of the line of sight environment, and makes the setting of the enabling of the second communication in a case of not the line of sight environment.

6. The communication apparatus according to claim 4, wherein
the propagation characteristic is a delay amount or a delay spread amount of a delay wave of communication in the communication apparatus, and
the control circuitry makes the setting of the enabling of the first communication when the delay amount or the delay spread amount is greater than or equal to a threshold value, and makes the setting of the enabling of the second communication when the delay amount or the delay spread amount is less than the threshold value.

7. The communication apparatus according to claim 1, wherein
the condition is based on an antenna gain in the communication apparatus, and
the control circuitry makes the setting of the enabling of the first communication when the antenna gain is greater than or equal to a threshold value, and makes the setting of the enabling of the second communication when the antenna gain is less than the threshold value.

8. The communication apparatus according to claim 1, wherein
the condition is based on a result of carrier sensing, and
in accordance with a radio frequency band determined to be usable by the carrier sensing, out of the first radio frequency band and the second radio frequency band, the control circuitry makes the setting of the enabling of the first communication or the setting of the enabling of the second communication.

9. The communication apparatus according to claim 1, wherein
the communication apparatus is a terminal, and
the condition is based on an instruction from a base station.

10. The communication apparatus according to claim 1, wherein
the communication apparatus is a terminal, and
the condition is based on at least one of a parameter related to wireless communication set in the communication apparatus, a propagation characteristic of the communication apparatus, directivity of an antenna in the communication apparatus, a result of carrier sensing, or an instruction from a base station.

11. The communication apparatus according to claim 1, wherein the control circuitry includes baseband processing circuitry which, in operation, performs baseband processing, the baseband processing circuitry being common to the first communication and the second communication.

12. The communication apparatus according to claim 11, wherein the control circuitry includes a first local oscillator which, in operation, generates a signal corresponding to the first radio frequency band and a second local oscillator which, in operation, generates a signal corresponding to the second radio frequency band.

13. The communication apparatus according to claim 11,
wherein the control circuitry includes: a first local oscillator which, in operation, generates a first signal corresponding to the first radio frequency band; and a second local oscillator which, in operation, generates a second signal corresponding to the second radio frequency band,
the communication circuitry includes an up-converter corresponding to the second radio frequency band, the upconverter being common to the first communication and the second communication, and
the first signal corresponds to a frequency equal to a difference in frequency between the first radio frequency band and the second radio frequency band.

14. The communication apparatus according to claim 11, wherein the control circuitry includes a local oscillator which, in operation, generates a first signal corresponding to the first radio frequency band, and a frequency divider which, in operation, divides a frequency of the first signal to generate a second signal corresponding to the second radio frequency band.

15. The communication apparatus according to claim 11,
wherein the control circuitry includes: a local oscillator which, in operation, generates a first signal corresponding to the first radio frequency band; and a frequency divider which, in operation, divides a frequency of the first signal to generate a second signal corresponding to the second radio frequency band,
the communication circuitry includes an up-converter corresponding to the second radio frequency band, the upconverter being common to the first communication and the second communication, and
the first signal corresponds to a frequency equal to a difference in frequency between the first radio frequency band and the second radio frequency band.

16. The communication apparatus according to claim 11, wherein the control circuitry includes a local oscillator which, in operation, switches between outputting a signal corresponding to the first radio frequency band and outputting a signal corresponding to the second radio frequency band.

17. A communication method performed by a communication apparatus, the communication method comprising:
in accordance with a condition, making a setting of enabling or disabling of first communication using a first radio frequency band and making a setting of enabling or disabling of second communication using a second radio frequency band lower than the first radio frequency band; and
performing the first communication or the second communication in accordance with the setting of the enabling or disabling of the first communication and the setting of the enabling or disabling of the second communication.
